(19) United States
(12) Patent Application Publication
(10) Pub. No.: US 2021/0091563 A1
(43) Pub. Date: Mar. 25, 2021

(54) POWER SUPPLY SYSTEM AND POWER SYNTHESIS DEVICE

(71) Applicant: SION ELECTRIC CO., LTD., Sapporo-shi, Hokkaido (JP)

(72) Inventors: Minoru MURANO, Sapporo-shi (JP); Shin TANAHASHI, Sapporo-shi (JP); Shinichi OZAKI, Sapporo-shi (JP)

(21) Appl. No.: 16/637,628

(22) PCT Filed: Aug. 31, 2018
(86) PCT No.: PCT/JP2018/032507

§ 371 Date: Dec. 4, 2020

(30) Foreign Application Priority Data
Sep. 1, 2017 (JP) 2017-169034

(51) Int. Cl. H02J 1/00; H02J 7/00; B60R 16/03

(52) U.S. Cl. CPC H02J 1/00; B60R 16/03; H02J 7/00712; H02J 7/0029

(57) ABSTRACT

A power supply system maintains or controls the output even if multiple power sources include a power source whose optimum output voltage varies. A power supply system includes a direct-current power supply mechanism that supplies direct-current power, a direct-current power storage mechanism that stores direct-current power, and a direct-current output terminal that outputs direct-current power supplied from the direct-current power supply mechanism, the direct-current power storage mechanism, or both to a direct-current load. An output of the direct-current power supply mechanism and the direct-current output terminal are connected directly or through a current backflow prevention mechanism. An input/output terminal of the direct-current power storage mechanism and the direct-current output terminal are connected directly or through a power backflow prevention mechanism. A target voltage of the direct-current power supply mechanism and a terminal voltage of the direct-current power storage mechanism are matched within a predetermined adaptive voltage range.

### TECHNICAL FIELD

The present invention relates a power supply system and power mixing apparatus.

### BACKGROUND ART

For example, Patent Literature 1 discloses a direct-current power source use system that aims to reduce the installation cost, to stably supply power to a direct-current load, and to improve the power supply ability. The direct-current power source use system includes a direct-current power source, an alternating-current commercial power source, a direct-current converter that converts the alternating-current commercial power source to a direct-current power source, and a direct-current load device that receives supply of direct-current power from both the direct-current power source and the commercial power source that has been converted into direct current. Backflow prevention diodes are disposed between the direct-current power source and direct-current load device and between the direct-current converter and direct-current load device. Also, a preferential power source supply device is disposed that causes the direct-current power source to preferentially supply power to the direct-current load, device. The Patent Literature 1 discloses that the direct-current power source use system is able to provide a simply control method capable of, even if the direct-current power source includes a solar cell and the amount of solar radiation is reduced, making the maximum use of power generated in the amount of solar radiation.

For example, Patent Literature 2 discloses a power delivery system that aims to select a desired power source and to use power without waste in a manner corresponding to the type of the selected power source. The power delivery system includes multiple direct-current power sources and a load that receives supply of direct-current power. The direct-current power sources are provided with preferential power extraction devices, and a controller determines the amount of power preferentially extracted from the direct-current power sources to the load by controlling the preferential power extraction devices. Patent Literature 2 discloses that the power delivery system is advantageously able to, when mixing power obtained from a commercial power source and power generated from various types of natural energy, make effective use of the small amount of power generated from the small amount of natural energy without waste, to use the multiple power sources in a combined manner, to, even if one power source is turned off, allow another power source to supply power automatically, and to, when using the multiple power sources, easily set the order of preferential use of the power sources.

For example, Patent Literature 3 discloses a power supply system for photovoltaic power generation that aims to, when the power consumption of a load exceeds power supply from a solar cell, extract power from the solar cell to the greatest extent. The power supply system for photovoltaic power generation includes a photovoltaic power source, a power source other than the photovoltaic power source, a power mixing apparatus that mixes power from the photovoltaic power source and power from the other power source, and a load that receives the power mixed by the power mixing apparatus. This power supply system detects a voltage value at which power can be obtained from the photovoltaic power source most efficiently, on the condition that power consumed by the load is approximately equal to or greater than power generated by the photovoltaic power source, sets the voltage value of the power source other than the photovoltaic power source to a voltage value approximately equal to the detected voltage value, mixes power from the photovoltaic power source and power from the other power source using the power mixing apparatus, and supplies the mixed power to the load.

### CITATION LIST

### Patent Literature

Patent Literature 1: Japanese Unexamined Patent Application Publication No. 2011-181055

Patent Literature 2: Japanese Unexamined Patent Application Publication No. 2014-121241

Patent Literature 3: Japanese Unexamined Patent Application Publication No. 2016-019415

### SUMMARY OF INVENTION

### Technical Problem

If a system that mixes direct-current power from multiple power sources and supplies the mixed power to a load, as described above, includes a power source whose output current varies with the output voltage, that is, a power source from which power varying with the output voltage is extracted, such as a solar cell, the system typically uses a controller of MPPT (maximum power point tracking) type, which automatically obtains the optimum current-voltage that maximize the output.

However, an MPPT controller itself can cause a power loss. Also, an MPPT controller employs the hill climbing method as a control method and uses a DC-DC converter, and therefore necessarily causes pulsed or sawtooth voltage variations that can degrade the storage batteries.

An object of the present invention is to provide a power supply system and power mixing apparatus that even if multiple power sources include a power source whose optimum output voltage varies, such as a solar cell, maintains or controls the output properly and increases the power generation efficiency of the entire system or apparatus. Another object of the present invention is to provide a power supply system and power mixing apparatus that, even if multiple power sources include a power source whose optimum output voltage varies, such as a solar cell, suppress degradation of storage batteries.

### Solution to Problem

To solve the above problem, a first aspect of the present invention provides a power supply system including a direct-current power supply mechanism that supplies direct-current power, a direct-current power storage mechanism that stores direct-current power, and a direct-current output terminal that outputs direct-current power supplied from the direct-current power supply mechanism, the direct-current power storage mechanism, or both to a direct-current load. An output of the direct-current power supply mechanism and the direct-current output terminal are connected directly or through a current backflow prevention mechanism. An input/output terminal of the direct-current power storage mechanism and the direct-current output terminal are connected directly or through a power backflow prevention mechanism. A target voltage of the direct-current power supply mechanism and a terminal voltage of the direct-current power storage mechanism are matched within a predetermined adaptive voltage range.

The direct-current power supply mechanism may include one or more direct-current generators. By controlling a connection state of the direct-current generators and thus controlling the target voltage of the direct-current power supply mechanism, the target voltage of the direct-current power supply mechanism and the terminal voltage of the direct-current power storage mechanism may be matched within the predetermined adaptive voltage range. The direct-current power supply mechanism may further include an alternating current-direct current converter that converts received alternating-current power into direct-current power. By controlling a connection state of the direct-current generators and the alternating current-direct current converter and thus controlling the target voltage of the direct-current power supply mechanism, the target voltage of the direct-current power supply mechanism and the terminal voltage of the direct-current power storage mechanism may be matched within the predetermined adaptive voltage range. The power supply system may further include a state switch mechanism that switches between connection states of the direct-current generators. By dynamically changing the number of series connections of the direct-current generators using the state switch mechanism, the target voltage of the direct-current power supply mechanism and the terminal voltage of the direct-current power storage mechanism may be matched within the predetermined adaptive voltage range. Note that by changing the output voltage of the alternating current-direct current converter, the target voltage of the direct-current power supply mechanism may be controlled.

The direct-current power storage mechanism may include one or more accumulators. By controlling a connection state of the accumulators and thus controlling the terminal voltage of the direct-current power storage mechanism, the target voltage of the direct-current power supply mechanism and the terminal voltage of the direct-current power storage mechanism may be matched within the predetermined adaptive voltage range. The direct-current power storage mechanism may include a vehicle storage battery mounted on an electric vehicle. By controlling a connection state of the accumulators and the vehicle storage battery and thus controlling the terminal voltage of the direct-current power storage mechanism, the target voltage of the direct-current power supply mechanism and the terminal voltage of the direct-current power storage mechanism may be matched within the predetermined adaptive voltage range. The power supply system may further include a state switch mechanism that switches between connection states of the accumulators. By dynamically changing the number of series connections of the accumulators using the state switch mechanism, the target voltage of the direct-current power supply mechanism and the terminal voltage of the direct-current power storage mechanism may be matched within the predetermined adaptive voltage range.

The direct-current power storage mechanism may be a vehicle storage battery mounted on an electric vehicle. The power supply system may further include a variable voltage source connected to the direct-current power storage mechanism in series. By controlling a voltage of the variable voltage source, the target voltage of the direct-current power supply mechanism and the terminal voltage of the direct-current power storage mechanism may be matched within the predetermined adaptive voltage range.

The power supply system may further include supply voltage measurement means that measures a voltage of the direct-current output terminal and interruption means that interrupts the connection between the input/output terminal of the direct-current power storage mechanism and the direct-current output terminal. When a voltage value of the direct-current output terminal measured by the supply voltage measurement means exceeds a predetermined charge end voltage, the interrupt means may interrupt the connection between the input/output terminal of the direct-current power storage mechanism and the direct-current output terminal. When the voltage value of the direct-current output terminal measured by the supply voltage measurement means falls below a predetermined charge restore voltage, the interrupt means may restore the connection between the input/output terminal of the direct-current power storage mechanism and the direct-current output terminal. When the voltage value of the direct-current output terminal measured by the supply voltage measurement means falls below a discharge end voltage, the interrupt means may interrupt the connection between the input/output terminal the direct-current power storage mechanism and the direct-current output terminal. When the voltage value of the direct-current output terminal measured by the supply voltage measurement means exceeds a predetermined discharge restore voltage, the interrupt means may restore the connection between the input/output terminal of the direct-current power storage mechanism and the direct-current output terminal. The power supply system may further include signal generation means that when the voltage value of the direct-current output terminal measured by the supply voltage measurement means exceeds the predetermined charge end voltage, outputs a surplus power generation signal. The power supply system may further include one or more loads that receive power supply from the direct-current power supply mechanism, the direct-current power storage mechanism, or both. When the surplus power generation signal is received, activation of a predetermined, less-important load of the loads may be permitted.

The direct-current power supply mechanism may include one or more renewable energy-based first power supply elements and one or more non-renewable energy-based second power supply elements. By setting target voltages of all the first power supply elements to higher values than maximum values of target voltages of the second power supply elements, power may be supplied more preferentially from the first power supply elements than from the second power supply elements. Target voltages of supply elements included in the first supply elements and the second supply elements may be determined in accordance with the order of the amount of power supply-related cost or other orders. Power may be preferentially supplied from supply elements having higher target voltages. Note that the target voltages may be determined by renewable energy-based power supply elements. If there are multiple renewable energy-based power supply elements, the respective target voltages may be matched within the predetermined adoptive voltage range.

The power supply system may further include power measurement means that measures the amount of power supplied from the second supply elements and signal generation means that when a value measured by the power measurement means exceeds a predetermined value, outputs a non-renewable energy-based power use signal. The power supply system may further include one or more loads that receive power supply from the direct-current power supply mechanism, the direct-current power storage mechanism, or both. When the non-renewable energy-based power use signal is received, activation of a predetermined, less-important load of the loads may be prohibited.

The power supply system may further include a direct current-alternating current converter that includes a direct-current input terminal and an alternating-current output terminal. The direct-current input terminal of the direct current-alternating current converter may be connected to the direct-current output terminal. The alternating-current output terminal of the direct current-alternating current converter may supply alternating-current power to an alternating-current load. The power supply system may further include an direct-current load connected to the direct-current output terminal. The direct-current load may be a direct-current electric device that can be activated at least in the entire adaptive voltage range, The power supply system may further include a direct-current load connected to the direct-current current output terminal. The direct-current load may be an electric heater using a filament, a heat pump device, a heat storage tank, a hydrogen generator, or a vehicle battery.

A second aspect of the present invention provides a power mixing apparatus include a direct-current power receiving terminal that receives direct-current power from a direct-current power supply mechanism, a direct-current power storage mechanism that stores direct-current power, and a direct-current output terminal that outputs direct-current power supplied from the direct-current power supply mechanism, the direct-current power storage mechanism, or both to a direct-current load. The direct-current power receiving terminal and the direct-current output terminal are connected directly or through a current backflow prevention mechanism. An input/output terminal of the direct-current power storage mechanism and the direct-current output terminal are connected directly or through a power backflow prevention mechanism. A target voltage of the direct-current power supply mechanism connected to the direct-current power receiving terminal and a terminal voltage of the direct-current power storage mechanism are matched within a predetermined adaptive voltage range.

The direct-current power storage mechanism may include one or more accumulators. By controlling a connection state of the accumulators and thus controlling the terminal voltage of the direct-current power storage mechanism, the target voltage of the direct-current power supply mechanism and the terminal voltage of the direct-current power storage mechanism may be matched within the predetermined adaptive voltage range. The direct-current power storage mechanism may include a vehicle storage battery mounted on an electric vehicle. By controlling a connection state of the accumulators and the vehicle storage battery and thus controlling the terminal voltage of the direct-current power storage mechanism, the target voltage of the direct-current power supply mechanism and the terminal voltage of the direct-current power storage mechanism may be matched within the predetermined adaptive voltage range. The power mixing apparatus may further include a state switch mechanism that switches between connection states of the accumulators. By dynamically changing the number of series connections of the accumulators using the state switch mechanism, the target voltage of the direct-current power supply mechanism and the terminal voltage of the direct-current power storage mechanism may be matched within the predetermined adaptive voltage range.

The power mixing apparatus may further include a variable voltage source connected to the direct-current power storage mechanism in series. By controlling a voltage of the variable voltage source, the target voltage of the direct-current power supply mechanism and the terminal voltage of the direct-current power storage mechanism may be matched within the predetermined adaptive voltage range.

The power mixing apparatus may further include supply voltage measurement means that measures a voltage of the direct-current output terminal and interruption means that interrupts the connection between the input/output terminal of the direct-current power storage mechanism and the direct-current output terminal. When a voltage value of the direct-current output terminal measured by the supply voltage measurement means exceeds a predetermined charge end voltage, the interrupt means may interrupt the connection between the input/output terminal of the direct-current power storage mechanism and the direct-current output terminal. When the voltage value of the direct-current output terminal measured by the supply voltage measurement means falls below a predetermined charge restore voltage, the interrupt means may restore the connection between the input/output terminal of the direct-current power storage mechanism and the direct-current output terminal. When the voltage value of the direct-current output terminal measured by the supply voltage measurement means falls below a predetermined discharge end voltage, the interrupt means may interrupt the connection between the input/output terminal of the direct-current power storage mechanism and the direct-current output terminal. When the voltage value of the direct-current output terminal measured by the supply voltage measurement means exceeds a predetermined discharge restore voltage, the interrupt means may restore the connection between the input/output terminal of the direct-current power storage mechanism and the direct-current output terminal. The power mixing apparatus may further include signal generation means that when the voltage value of the direct-current output terminal measured by the supply voltage measurement means exceeds the predetermined charge end voltage, outputs a surplus power generation signal.

The power mixing apparatus may further include a direct current-alternating current converter that includes a direct-current input terminal and an alternating-current output terminal. The direct-current input terminal of the direct current-alternating current converter may be connected to the direct-current output terminal. The alternating-current output terminal of the direct current-alternating current converter may supply alternating-current power to an alternating-current load.

The summary of the invention does not describe all the required features of the present invention. Subcombinations of the features can also serve as the invention.

### BRIEF DESCRIPTION OF THE DRAWINGS

FIG. 1 is a function block diagram showing a power supply system 100.

FIG. 2 is a graph showing the operation of the power supply system 100.

FIG. 3 is a circuit block diagram showing an example of a direct-current power supply mechanism 120.

FIG. 4 is a circuit block diagram showing another example of the direct-current power supply mechanism 120.

FIG. 5 is a circuit block diagram showing an example of a direct-current power storage mechanism 140.

FIG. 6 is a circuit block diagram showing another example of the direct-current power storage mechanism 140.

FIG. 7 is a function block diagram showing a power supply system 200.

FIG. 8 is a function block diagram showing a power supply system 300.

FIG. 9 is a function block diagram showing a power supply system 400.

FIG. 10 is a circuit diagram showing an example of interruption means 420.

FIG. 11 is a function block diagram showing a power supply system 500.

FIG. 12 is a function block diagram showing a power supply system 600.

FIG. 13 is a function block diagram showing a power supply system 700.

FIG. 14 is a function block diagram showing a power supply system 800.

FIG. 15 is a function block diagram showing a power supply system 900.

FIG. 16 is a function block diagram showing a power supply system 1000.

FIG. 17 is a graph showing (time-dependent) changes in the power output of a power supply system of Example along with those of Comparative Example.

### DESCRIPTION OF EMBODIMENTS

While the present invention will be described below through an embodiment thereof, the claimed invention is not limited to the embodiment. All combinations of the features described in the embodiment are not essential to the solving means of the invention.

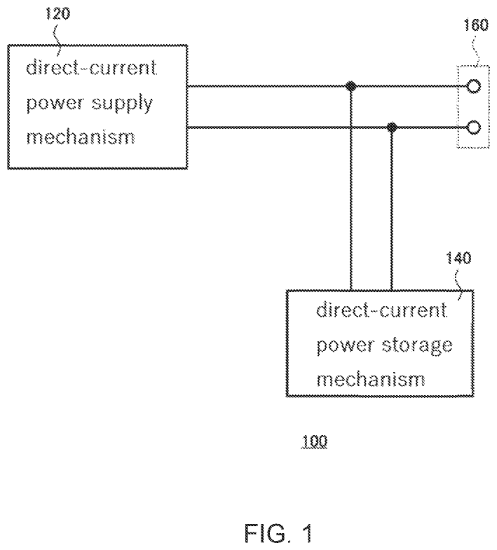

FIG. 1 is a function block diagram showing a power supply system 100. The power supply system 100 includes a direct-current power supply mechanism 120, a direct-current power storage mechanism 140, and a direct-current output terminal 160 The direct-current power supply mechanism 120 supplies direct-current power, and the direct-current power storage mechanism 140 stores direct-current power. The direct-current output terminal 160 outputs direct-current power supplied from the direct-current power supply mechanism 120, direct-current power storage mechanism 140, or both to a direct-current load.

The output of the direct-current power supply mechanism 120 and the direct-current output terminal 160, and the input/output terminal of the direct-current power storage mechanism 140 and the direct-current output terminal 160 are directly connected not through an MPPT controller or the like. Thus, there is no power loss due to an MPPT controller or the like, allowing for formation of an highly efficient power supply system. Also, there are no pulsed or sawtooth voltage variations due to an MPPT controller or the like, allowing for preventing degradation of storage batteries.

In the power supply system 100, the target voltage of the direct-current power supply mechanism 120 and the terminal voltage of the direct current power storage mechanism 140 are matched within a predetermined adaptive voltage range ΔV. Thus, power can be extracted highly efficiently from a generator, such as a solar cell, included in the direct-current power supply mechanism 120.

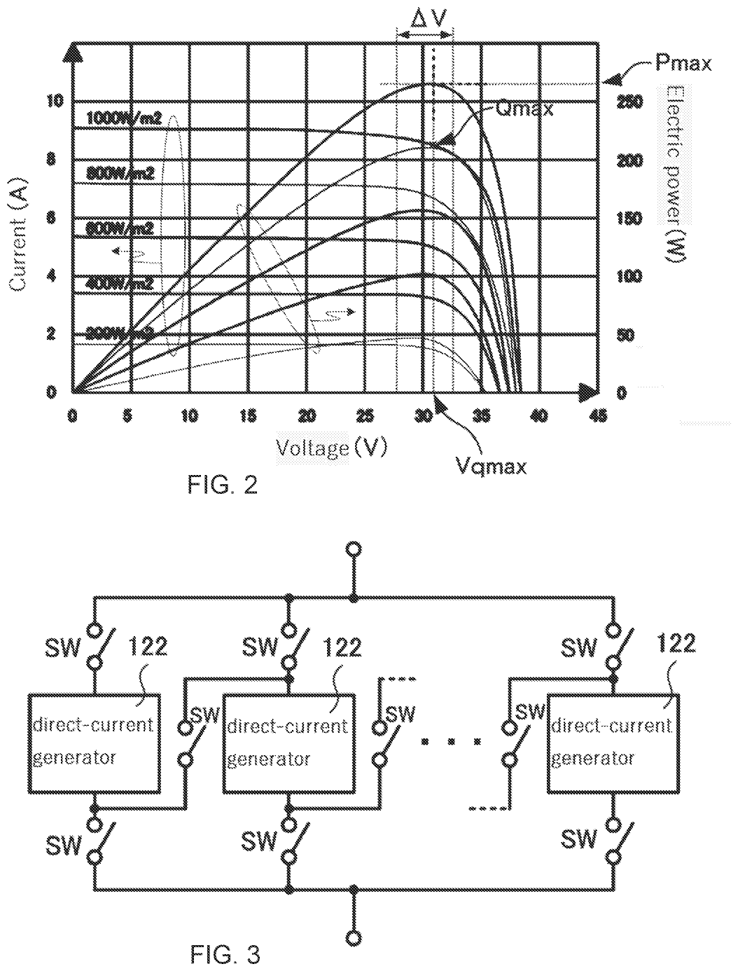

FIG. 2 is a graph showing the operation of the power supply system 100. A graph referring to the left axis of FIG. 2 shows I-V characteristics (current-voltage characteristics) of a solar cell. In a low-voltage range, a constant current is outputted in accordance with the amount of light radiation. When the voltage is increased, the output current is suddenly reduced. A graph referring to the right axis shows such characteristics using power. The output power is increased as the voltage is increased. After reaching the maximum output power Pmax, the output power is reduced. A point on the I-V characteristics indicating Pmax is the maximum output operation point Qmax, and its voltage is the maximum output operation voltage Vqmax. In the case of a solar cell, generally, power is most efficiently extracted therefrom when the output voltage is controlled to the maximum output operation voltage Vqmax. Accordingly, the target voltage of the direct-current power supply mechanism 120 including a solar cell is preferably controlled to the maximum output operation voltage Vqmax. An conventional MPPT controller automatically precisely performs such voltage control.

On the other hand, the power supply system 100 does not have to precisely perform such voltage control but rather only requires that the target voltage of the direct-current power supply mechanism 120 and the terminal voltage of the direct-current power storage mechanism 140 be matched within the adaptive voltage range ΔV. Since the target voltage of the direct-current power supply mechanism 120 is controlled within the adaptive voltage range ΔV, there is no need to use an MPPT controller, although the extractable power slightly departs from the maximum power. As a result, there is no power loss due to an MPPT controller, allowing for extracting power more efficiently than when using an MPPT controller. Also, there are no pulsed or sawtooth voltage variations due to an MPPT controller, allowing for preventing degradation of the storage batteries.

The target voltage of the direct-current power supply mechanism 120 and the terminal voltage of the direct-current power storage mechanism 140 can be matched within the adaptive voltage range ΔV by changing the target voltage of the direct-current power supply mechanism 120, or the terminal voltage of the direct-current power storage mechanism 140, or both.

First, a case will be described in which by changing the target voltage of the direct-current power supply mechanism 120, the target voltage of the direct-current power supply mechanism 120 and the terminal voltage of the direct-current power storage mechanism 140 are matched within the adaptive voltage range ΔV. FIG. 3 is a circuit block diagram showing an example of the direct-current power supply mechanism 120, The direct-current power supply mechanism 120 shown in FIG. 3 includes multiple direct-current generators 122. The target voltage of the direct-current power supply mechanism 120 is controlled by controlling the connection state of the direct-current generators 122. The direct-current generators 122 are electric devices that output direct-current power and are, for example, solar cells, fuel cells, or the like. The direct-current generators 122 are preferably renewable energy. By controlling the target voltage of the direct-current power supply mechanism 120, the target voltage of the direct-current power supply mechanism 120 and the terminal voltage of the direct-current power storage mechanism 140 can be matched within the adaptive voltage range ΔV.

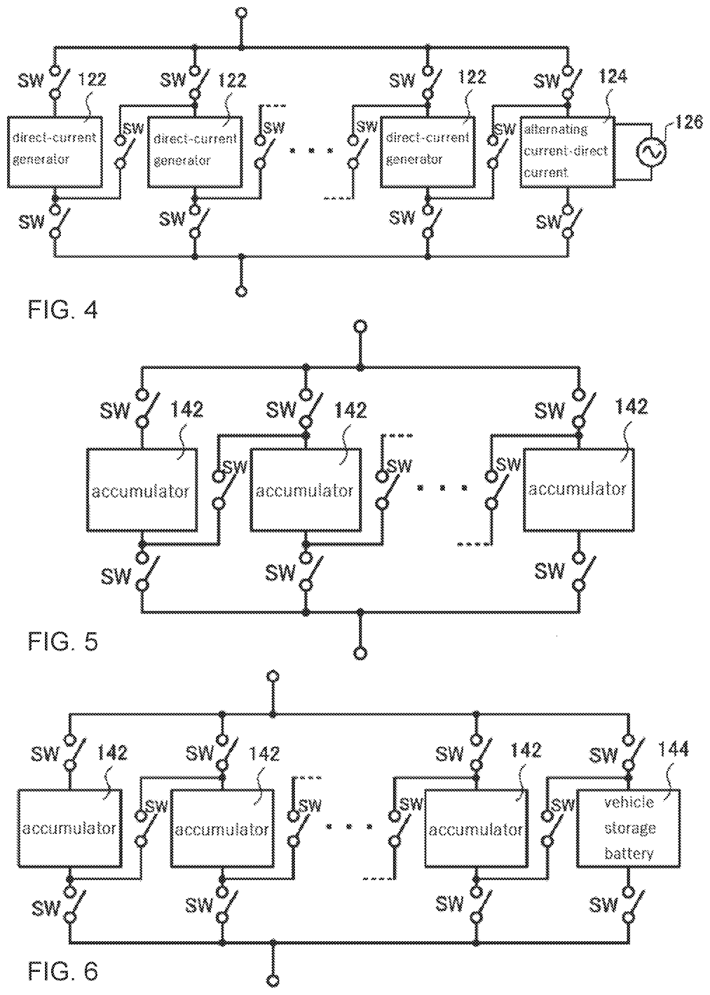

FIG. 4 is a circuit block diagram showing another example of the direct-current power supply mechanism 120. A direct-current power supply mechanism 120 shown in FIG. 3 includes direct-current generators 122, as well as an alternating current-direct current converter 124 that converts received alternating-current power 126 into direct-current power. By controlling the connection state of the direct-current generators 122 and alternating current-direct current converter 124, the target voltage of the direct-current power supply mechanism 120 is controlled. By controlling the target voltage of the direct-current power supply mechanism 120, the target voltage of the direct-current power supply mechanism 120 and the terminal voltage of the direct-current power storage mechanism 140 can be matched within the adaptive voltage range ΔV.

Note that when inputting the alternating current power 126 to the alternating current-direct current converter 124, the input voltage may be controlled using an isolation transformer or autotransformer. Use of an isolation transformer allows for insolating the output-side direct-current circuit of the alternating current-direct current converter 124 from the input-side alternating-current circuit thereof, allowing for arbitrarily designing the reference potential of the direct-current circuit regardless of the ground potential of the alternating-current circuit. On the other hand, use of an autotransformer does not isolate the output-side direct-current circuit and the input-side alternating-current circuit from each other. The alternating-current power 126 is, for example, commercial system power or alternating-current output renewable energy, such as wind power or geothermal heat.

The circuits in FIGS. 3 and 4 include switches SW capable of arbitrarily switching between the connection states of the direct-current generators 122 and alternating current-direct current converter 124, that the series/parallel states. The switches SW are an example of state switch mechanisms that switch between the connection states of the direct-current generators 122 and alternating current-direct current converter 124. The state switch mechanisms are mechanisms that arbitrarily switch the connection state of the electric devices, such as the direct-current generators 122, to a series connection, a parallel connection, or a combination thereof. For example, relay switches disposed between the electric devices are able to arbitrarily switch between series/parallel combinations. By dynamically change the number of series connections of the direct-current generators 122 using the state switch mechanisms, the target voltage of the direct-current power supply mechanism 120 and the terminal voltage of the direct-current power storage mechanism 140 can be matched within the adaptive voltage range ΔV.

For example, if the number of series connections is changed and thus the number of series connections of the direct-current generators 122 becomes half or less of the total number of the direct-current generators 122, two sets of “series-connected direct-current generators” can be formed and the output current can be increased by connecting the two sets in parallel. If the number of series connections of the direct-current generators 122 becomes ⅓ or less of the total number of direct-current generators 122, three sets of “series-connected direct-current generators” can be formed and the output current can be increased by connecting the three sets in parallel. The same also applies to cases which the number of series connections becomes ¼ or less, ⅕ or less, or the like of the total number The minimum number of series connections is 1. At this time, a number of parallel connections corresponding to the total number can he formed. Note that the number of series connections may not match the number of combinations. In this case, multiple sets cannot be connected in parallel, and power of an unconnectable direct-current generator 122 is not used. In this case, exceptionally, it is possible to make a comparison with a combination in which the voltage is closest to the predetermined adaptive voltage range ΔV and there is no unconnectable direct-current generator 122 and to select a method by which maximum power is obtained.

By changing the target voltage of the direct-current power supply mechanism 120 as described above, the target voltage of the direct-current power supply mechanism 120 and the terminal voltage of the direct-current power storage mechanism 140 can be matched within the adaptive voltage range ΔV.

Next, a case will be described in which by changing the terminal voltage of the direct-current power storage mechanism 140, the target voltage of the direct-current power supply mechanism 120 and the terminal voltage of the direct-current power storage mechanism 140 are matched within the adaptive voltage range ΔV. FIG. 5 is a circuit block diagram showing an example of the direct-current power storage mechanism 140. The direct-current power storage mechanism 140 shown in FIG. 5 includes multiple accumulators 142. The terminal voltage of the direct-current power storage mechanism 140 is controlled by controlling the connection state of the accumulators 142. The accumulators 142 are electric devices capable of storing direct-current power and are, for example, storage batteries or capacitors. By controlling the terminal voltage of the direct-current power storage mechanism 140, the target voltage of the direct-current power supply mechanism 120 and the terminal voltage of the direct-current power storage mechanism 140 can be matched within the adaptive voltage range ΔV. If there is an unconnected accumulator 142, it is possible to reduce the differences among the amounts of power charged in the accumulators 142 by switching between the unconnected accumulator 142 and a connected accumulator 142 every predetermined time (e.g., every several minutes).

FIG. 6 is a circuit block diagram showing another example of the direct-current power storage mechanism 140. A direct-current power storage mechanism 140 shown in FIG. 6 includes multiple accumulators 142, as well as a vehicle storage battery 144 mounted on an electric vehicle. By controlling the connection state of the accumulators 142 and vehicle storage battery 144, the target. voltage of the direct-current power storage mechanism 140 is controlled. By controlling the terminal voltage of the direct-current power storage mechanism 140, the target voltage of the direct-current power supply mechanism 120 and the terminal voltage of the direct-current power storage mechanism 140 can be matched within the predetermined adaptive voltage range ΔV.

The circuits in FIGS. 5 and 6 include switches SW capable of arbitrarily switching between the connection states of the accumulators 142 and vehicle storage battery 144, that is, the series/parallel states. The switches SW are an example of state switch mechanisms that switch between the connection states of the accumulators 142 and vehicle storage battery 144. The state switch mechanisms are mechanisms that arbitrarily switch the connection state of the electric devices, such as the accumulators 142, to a series connection, a parallel connection, or a combination thereof. For example, relay switches disposed between the electric devices are able to arbitrarily switch between series/parallel combinations. By dynamically change the number of series connections of the accumulators 142 using the state switch mechanisms, the target voltage of the direct-current power supply mechanism 120 and the terminal voltage of the direct-current power storage mechanism 140 can be matched within the adaptive voltage range ΔV.

By changing the terminal voltage of the direct-current power storage mechanism 140 as described above, the target voltage of the direct-current power supply mechanism 120 and the terminal voltage of the direct-current power storage mechanism 140 can be matched within the adaptive voltage range ΔV. Note that by combining the configurations in FIGS. 3 to 6 and changing both the target voltage of the direct-current power supply mechanism 120 and the terminal voltage of the direct-current power storage mechanism 140, the target voltage of the direct-current power supply mechanism 120 and the terminal voltage of the direct-current power storage mechanism 140 may be matched within the adaptive voltage range ΔV.

Specific examples of the adaptive voltage range ΔV are as follows.
(1) Range from (maximum output operation voltage Vqmax−½ of voltage of accumulators 142) to (maximum output operation voltage Vqmax+½ of voltage of accumulators 142);
(2) Range from lower-limit voltage to upper-limit voltage where maximum output voltage Pmax becomes 70%, preferably range from lower-limit voltage to upper-limit voltage where Pmax becomes 80%, more preferably range from lower-limit voltage to upper-limit voltage where Pmax becomes 90%; and
(3) Range from (maximum output operation voltage Vqmax−electromotive voltage of N direct-current generators 122) to (maximum output operation voltage Vqmax+electromotive voltage of N direct-current generators 122) where N is 5, preferably 3, more preferably 1.

Note that the direct-current power storage mechanism 140 need not necessarily include the one or more accumulators 142 and may include only the vehicle storage battery 144 mounted on the electric vehicle.

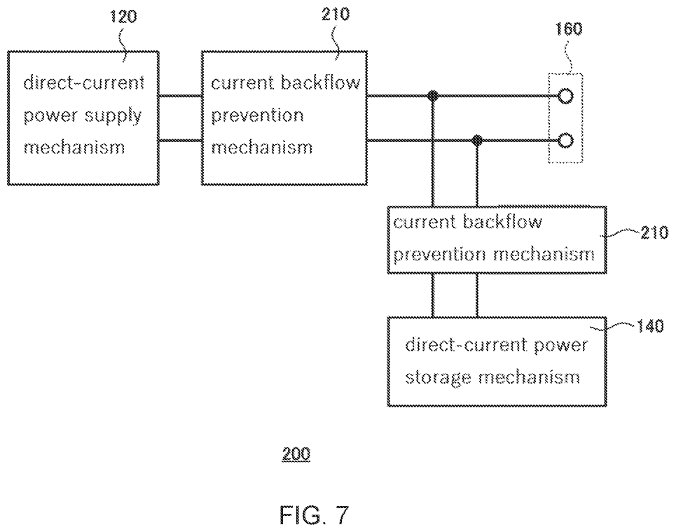

FIG. 7 is a function block diagram showing a power supply system 200. The power supply system 200 includes the elements of the power supply system 100, as well as current backflow prevention mechanisms 210. Elements similar to those of the power supply system 100 included the power supply system 200 will not be described.

The current backflow prevention mechanisms 210 are electric devices for stopping a current that attempts to flow in a direction reverse to a predetermined direction and are, for example, relays or backflow prevention diodes. The current backflow prevention mechanisms 210 are located between the output of a direct-current power supply mechanism 120 and a direct-current output terminal 160 and between the input/output terminal of a direct-current power storage mechanism 140 and the direct-current output terminal 160. That is, the output of the direct-current power supply mechanism 120 and the direct-current output terminal 160, and the input/output terminal of the direct-current power storage mechanism 140 and the direct-current output terminal 160 are connected through the current backflow prevention mechanisms 210.

The connections through the current backflow prevention mechanisms 210 allow for avoiding a failure, such as a device failure, due to backflow of a current.

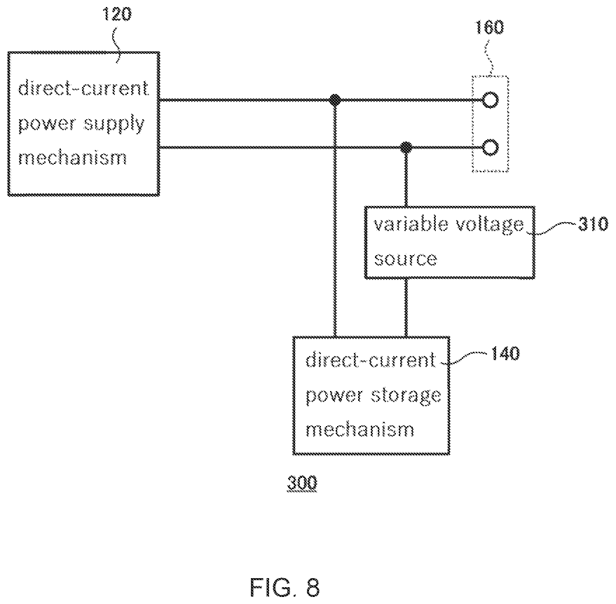

FIG. 8 is a function block diagram showing a power supply system 300. The power supply system 300 includes the elements of the power supply system 100, as well as a variable voltage source 310. Elements similar to those of the power supply system 100 included the power supply system 300 will not be described.

The variable voltage source 310 is a direct-current voltage source that is connected to a direct-current power storage mechanism 140 in series and whose output voltage is arbitrarily variable. Preferably, the internal impedance of the variable voltage source 310 is small to the extent that a sufficient current can be passed through the input/output terminal of the direct-current power storage mechanism 140. Also, preferably, the variable voltage source 310 accommodates both of the positive and negative current directions.

By controlling the voltage of the variable voltage source 310, the target voltage of a direct-current power supply mechanism 120 and the terminal voltage of the direct-current power storage mechanism 140 can be matched within a predetermined adaptive voltage range ΔV.

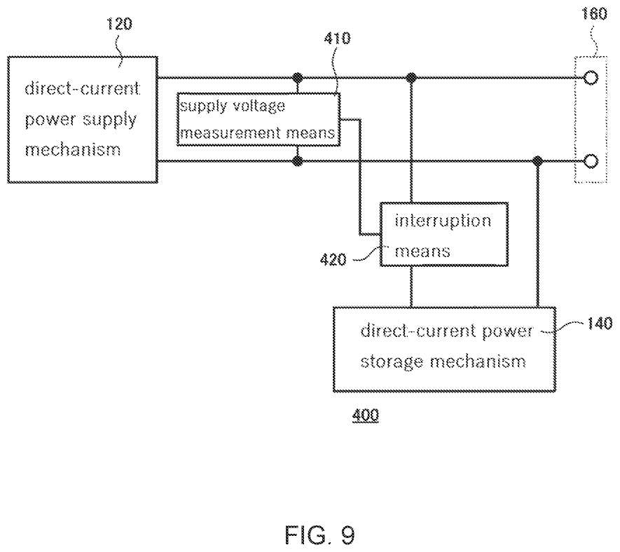

FIG. 9 is a function block diagram showing a power supply system 400. The power supply system 400 includes the elements of the power supply system 100, as well as supply voltage measurement means 410 and interruption means 420. Elements similar to those of the power supply system 100 included the power supply system 400 will not be described.

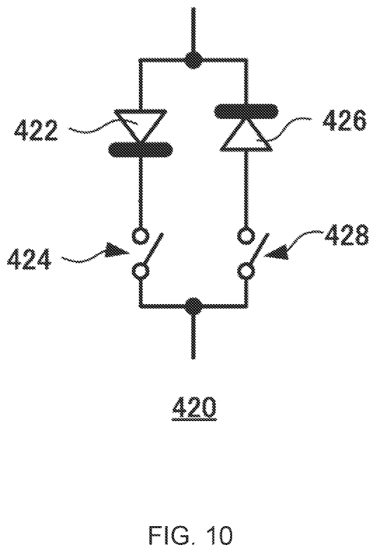

The supply voltage measurement means 410 measures the voltage of a direct-current output terminal 160. The interruption means 420 interrupts the connection between the input/output terminal of a direct-current power storage mechanism 140 and the direct-current output terminal 160. FIG. 10 is a circuit diagram showing an example of the interruption means 420. Backflow prevention diodes 422 and 426 and switches 424 and 428 are connected to each other in series. The diode 422 and switch 424 form a charge control circuit, and the diode 426 and switch 428 form a discharge control circuit.

When the voltage value of the direct-current output terminal 160 measured by the supply voltage measurement means 410 exceeds a predetermined charge end voltage, the interruption means 420 interrupts the connection between the input/output terminal of the direct-current power storage mechanism 140 and the direct-current output terminal 160. This allows for preventing overcharging the direct-current power storage mechanism 140, allowing for increasing the life of the storage batteries. The charge end voltage is, for example, the voltage when the accumulators have been fully charged.

When the voltage value of the direct-current output terminal 160 measured by the supply voltage measurement means 410 falls below a predetermined charge restore voltage, the interruption means 420 restores the connection between the input/output terminal of the direct-current power storage mechanism 140 and the direct-current output terminal 160. This allows for recharging the direct-current power storage mechanism 140. The charge restore voltage can be set to a voltage that is equal to or lower than the charge end voltage.

When the voltage value of the direct-current output terminal 160 measured by the supply voltage measurement means 410 falls below a predetermined discharge end voltage, the interruption means 420 interrupts the connection between the input/output terminal of the direct-current power storage mechanism 140 and the direct-current output terminal 160. This allows for preventing overdischarging the direct-current power storage mechanism 140, allowing for increasing the life of the storage battery. The discharge end voltage is, for example, the voltage when the accumulators have been fully discharged.

When the voltage value of the direct-current output terminal 160 measured by the supply voltage measurement means 410 exceeds a predetermined discharge restore voltage, the interruption means 420 restores the connection between the input/output terminal of the direct-current power storage mechanism 140 and the direct-current output terminal 160. This allows for reactivating the direct-current power storage mechanism 140. The discharge restore voltage can be set to a voltage that is equal to or higher than the discharge end voltage.

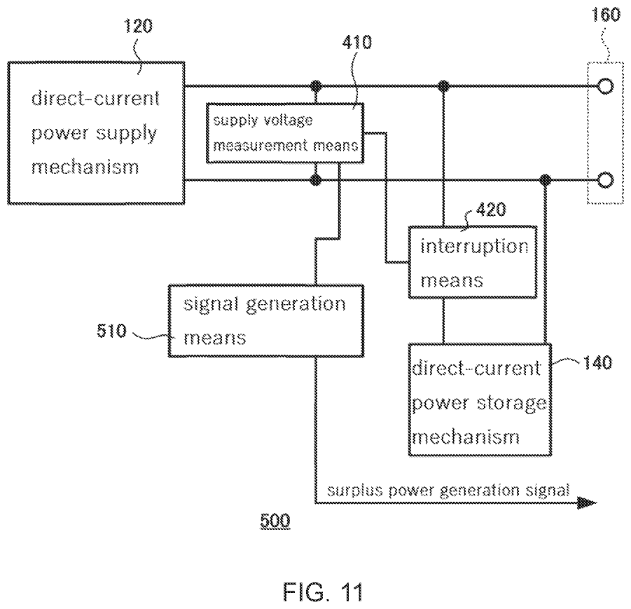

FIG. 11 is a function block diagram showing a power supply system 500. The power supply system 500 includes the elements of the power supply system 400, as well as signal generation means 510. Elements similar to those of the power supply system 400 included the power supply system 500 will not be described.

If the voltage value of a direct-current output terminal 160 measured by supply voltage measurement means 410 exceeds a predetermined charge end voltage, the signal generation means 510 outputs a surplus power generation signal. Use of the surplus power generation signal outputted by the signal generation means 510 allows for activating a load that is permitted to be activated when surplus power is generated, allowing for effectively using the surplus power.

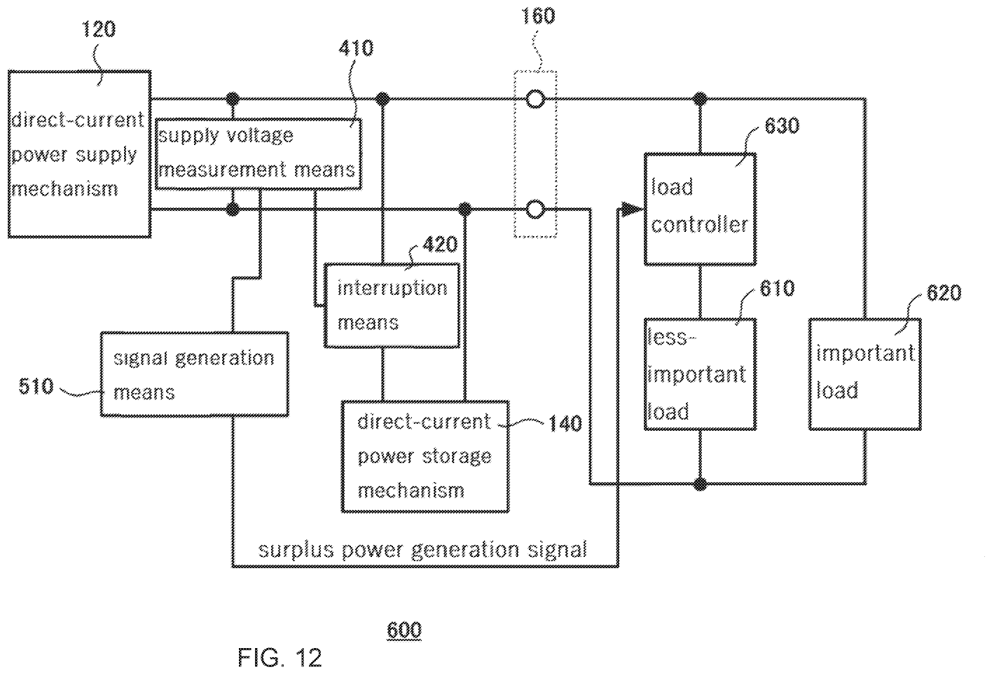

FIG. 12 is a function block diagram showing a power supply system 600. The power supply system 600 includes the elements of the power supply system 500, as well as a less-important load 610, an important load 620, and a load controller 630. Elements similar to those of the power supply system 500 included. the power supply system 600 will not be described.

The less-important load 610 and important load 620 are loads that receive supply of power from a direct-current power supply mechanism 120, a direct-current power storage mechanism 140, or both. The less-important load 610 is a predetermined less-important load. The less-important load 610 is connected to the load controller 630. When the load controller 630 receives a surplus power generation signal, it permits activation of the less-important load 610, allowing for effectively utilizing surplus power.

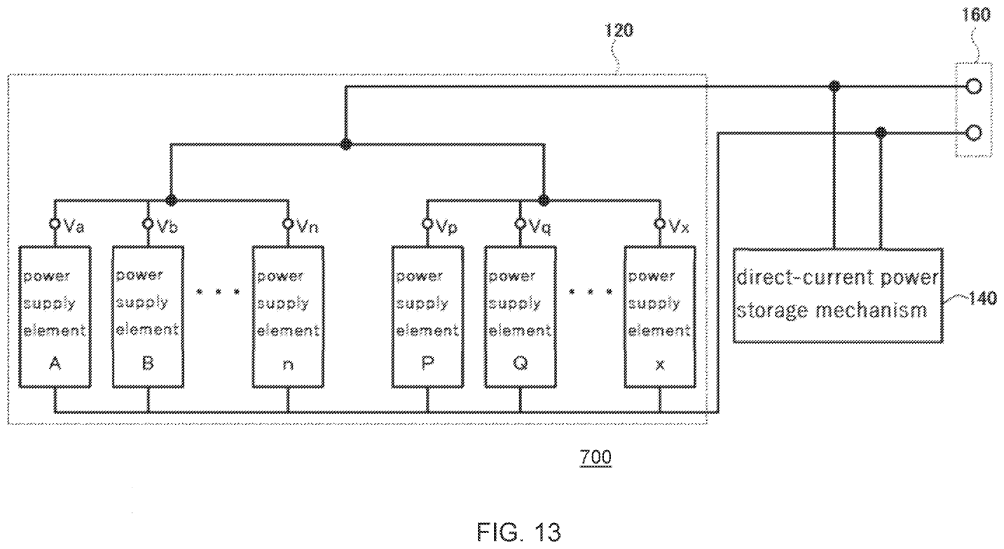

FIG. 13 is a function block diagram showing a power supply system 700. The power supply system 700 describes the direct-current power supply mechanism 120 of the power supply system 100 as another example. Elements similar to those of the power supply system 100 included the power supply system 700 will not be described.

A direct-current power supply mechanism 120 of the power supply system 700 includes multiple power supply elements A to x. Indexes n and x are not constant indexes but are variable indexes that vary with the number of power supply elements. That is, the number of power supply elements A to n is arbitrary, and the number of power supply elements P to x is also arbitrary. The power supply elements A to n are an example of one or more renewable energy-based first power supply elements, and the power supply elements P to x are an example of one or more non-renewable energy-based second power supply elements.

The target voltages Va to Vn of all the first power supply elements (power supply elements A to n) are set to higher values than the maximum values of the target voltages Vp to Vx of the second power supply elements (power supply elements P to x). Thus, power is supplied more preferentially from the first power supply elements than from the second power supply elements. As a result, power is preferentially supplied from the renewable energy-based power sources, making this power supply system friendly to the Earth.

The target voltages of the power supply elements included in the first power supply elements and second power supply elements are determined in accordance with the order of the amount of the power supply-related cost or other orders, and power is preferentially supplied from the supply elements having higher target voltages. As a result, power can be preferentially supplied from lower-cost power sources.

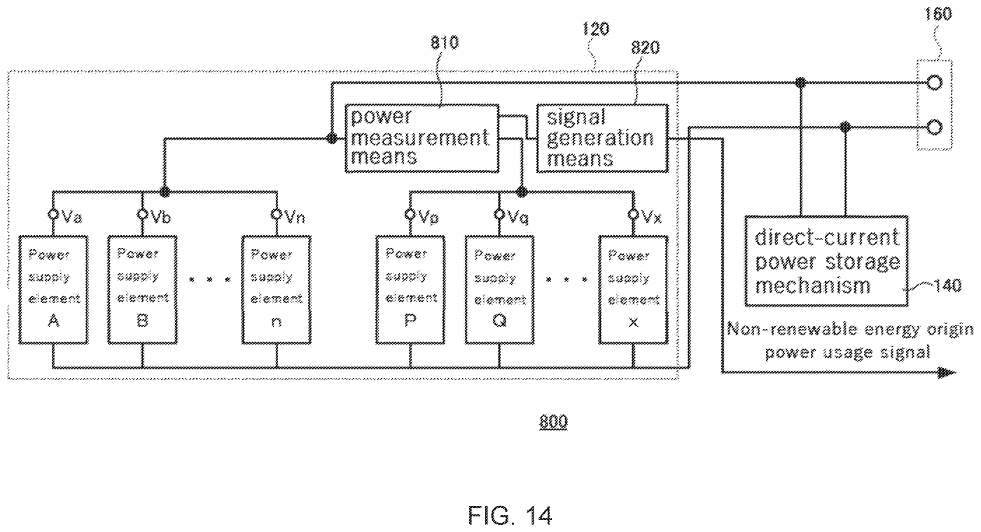

FIG. 14 is a function block diagram showing a power supply system 800. The power supply system 800 includes the elements of the power supply system 700, as well as power measurement means 810 and signal generation means 820. Elements similar to those of the power supply system 700 included the power supply system 800 will not be described.

The power measurement means 810 measures the amount of power supplied from second supply elements. If the value measured by the power measurement means 810 exceeds a predetermined value, the signal generation means 820 outputs a non-renewable energy-based power use signal. Use of the non-renewable energy-based power use signal allows for, for example, prohibition of use of a less-important power source.

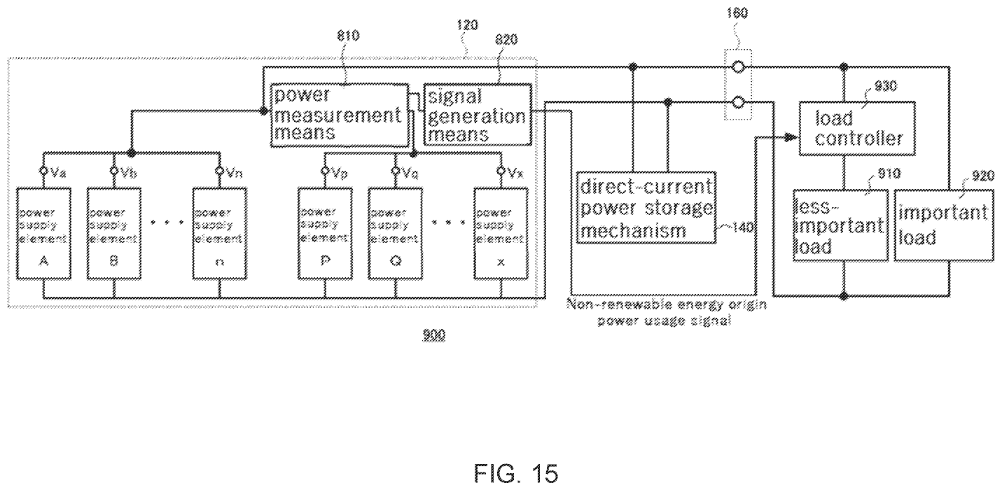

FIG. 15 is a function block diagram showing a power supply system 900. The power supply system 900 includes the elements of the power supply system 800, as well as a less-important load 910, an important load 920, and a load controller 930. Elements similar to those of the power supply system 800 included the power supply system 900 will not be described.

The less-important load 910 and important load 920 are loads that receive power supply from a direct-current power supply mechanism 120, a direct-current power storage mechanism 140, or both. The less-important load 910 is a predetermined less-important load. The less-important load 910 is connected to the load controller 930. When the load controller 930 receives a non-renewable energy-based power use signal, it prohibits activation of the less-important load 910, allowing for minimizing use of non-renewable energy-based power.

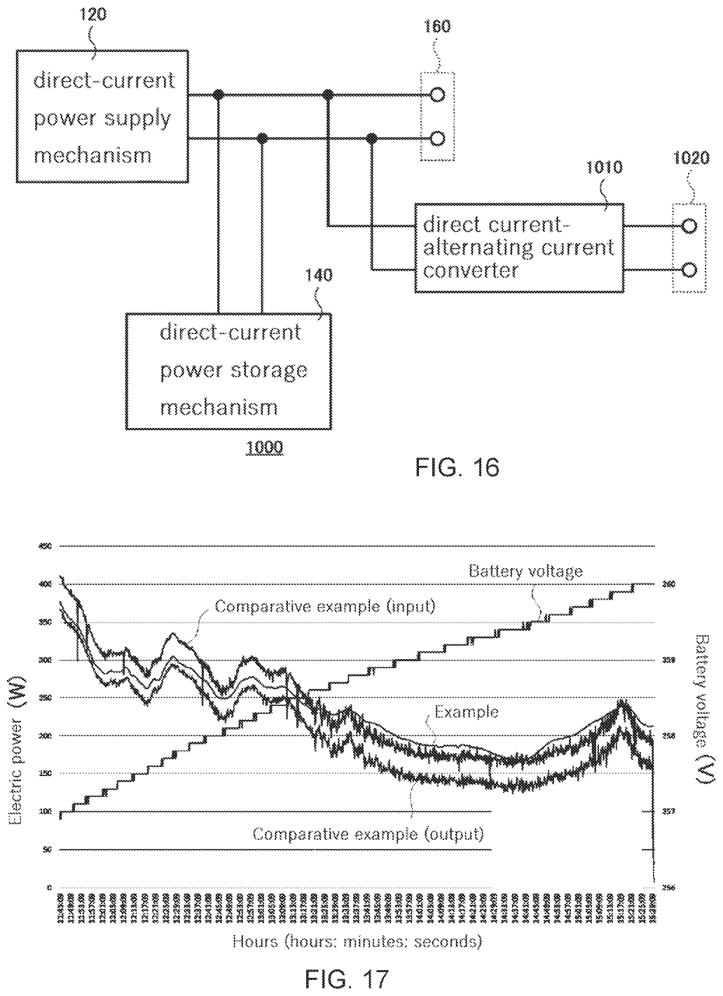

FIG. 16 is a function block diagram showing a power supply system 1000. The power supply system 1000 includes the elements of the power supply system 100, as well as a direct current-alternating current converter 1010. Elements similar to those of the power supply system 100 included the power supply system 1000 will not be described.

The direct current-alternating current converter 1010 includes a direct-current input terminal and an alternating-current output terminal 1020. The direct-current input terminal of the direct current-alternating current converter 1010 is connected to a direct-current output terminal 160, and the alternating-current output terminal 1020 thereof supplies alternating-current power to an alternating-current load. This configuration allows for supplying power to the alternating-current load through the alternating-current output terminal 1020. To control the alternating-current output voltage, the direct current-alternating current converter 1010 may include a transformer. To control the alternating-current voltage supplied to the alternating-current load, a transformer may be disposed between the alternating-current output terminal 1020 and alternating-current load.

The elements of the above-mentioned power supply systems 100 to 1000 can be combined with each other without departing from the principles. Also, the power supply systems 100 to 1000 may include a direct-current load connected to the direct-current output terminal 160. The direct-current load is, for example, a direct-current electric device that can be activated at least in the entire adaptive voltage range ΔV. Also, the direct-current load is, for example, an electric heater using a filament, a heat pump device, a heat storage tank, a hydrogen generator, or a vehicle battery.

### EXAMPLE

FIG. 17 is a graph showing (time-dependent) changes in the power output of a power supply system of Example along with those of Comparative Example. In Example, solar cells were used as a direct-current power supply mechanism 120, and storage batteries were used as a direct-current power storage mechanism 140. In Example, the target voltages of the solar cells and the terminal voltages of the storage batteries were matched within an adaptive voltage range ΔV by changing the number of series connections of the storage batteries and thus changing the terminal voltages thereof. In Comparative Example, a conventional MPPT controller was used.

FIG. 17 shows results obtained by measuring the power output based on actual solar radiation. The average output of Example was 236.1 W, and the average output of Comparative Example was 203.6 W. In Example, greater power than that of Comparative Example was outputted. Since the power value measured at the input stage of the MPPT controller of Comparative Example was 238.6 W, it can be said that the loss due to use of the MPPT controller was 1-203.6/238.6-approximately 15%. On the other hand, the average output of Example was approximately the same as the power value at the input stage of the MPPT controller. Also, power was extracted with efficiency comparable to that when the MPPT controller was used, and there was no loss due to use of an MPPT controller. Accordingly, it can be said that efficiency corresponding to approximately 99% of that when power is ideally extracted could be achieved, that is, it is understood that extremely high efficiency could be achieved. In other words, it is understood that the power supply system of Example does not cause degradation of the storage batteries due to pulsed or sawtooth voltage variations.

Also, in Comparative Example using the MPPT controller, pulsed or sawtooth voltage variations occurred. On the other hand, in Example such voltage variations were not found. That is, it is understood that the power supply system of Example does not cause degradation of the storage batteries due to pulsed or sawtooth voltage variations.

While the present invention has been described using the embodiment, the technical scope of the present invention is not limited to the technical scope described in the embodiment. It will be apparent for those skilled in the art that various changes or improvements can be made to the above embodiment. It is apparent from the description of the claims that such changed or improved forms can also be included in the technical scope of the present invention.

If the direct-current power supply mechanism 120 is removed from the power supply system of the above embodiment, the resulting entity can be grasped as a power mixing apparatus. That is, the resulting entity can be grasped as the following power mixing apparatus.
(1) A power mixing apparatus includes a direct-current power receiving terminal that receives direct-current power from a direct-current power supply mechanism 120, a direct-current power storage mechanism 140 that stores direct-current power, and a direct-current output terminal 160 that outputs direct-current power supplied from the direct-current power supply mechanism 120, the direct-current power storage mechanism 140, or both to a direct-current load. The direct-current power receiving terminal and the direct-current output terminal 160 are connected directly or through a current backflow prevention mechanism 210. An input/output terminal of the direct-current power storage mechanism 140 and the direct-current output terminal 160 are connected directly or through a power backflow prevention mechanism 210. A target voltage of the direct-current power supply mechanism 120 connected to the direct-current power receiving terminal and a terminal voltage of the direct-current power storage mechanism 140 are matched within a predetermined adaptive voltage range ΔV.
(2) In the power mixing apparatus, the direct-current power storage mechanism 140 includes one or more accumulators 142. By controlling a connection state of the accumulators 142 and thus controlling the terminal voltage of the direct-current power storage mechanism 140, the target voltage of the direct-current power supply mechanism 120 and the terminal voltage of the direct-current power storage mechanism 140 are matched within the predetermined adaptive voltage range ΔV.
(3) In the power mixing apparatus, the direct-current power storage mechanism 140 includes a vehicle storage battery 144 mounted on an electric vehicle. By controlling a connection state of the accumulators 142 and the vehicle storage battery 144 and thus controlling the terminal voltage of the direct-current power storage mechanism 140, the target voltage of the direct-current power supply mechanism 120 and the terminal voltage of the direct-current power storage mechanism 140 are matched within the predetermined adaptive voltage range ΔV.
(4) The power mixing apparatus further includes a state switch mechanism that switches between connection states of the accumulators 142. By dynamically changing the number of series connections of the accumulators 142 using the state switch mechanism, the target voltage of the direct-current power supply mechanism 120 and the terminal voltage of the direct-current power storage mechanism 140 are matched within the predetermined adaptive voltage range ΔV.
(5) The power mixing apparatus further includes a variable voltage source 310 connected to the direct-current power storage mechanism 140 in series. By controlling a voltage of the variable voltage source 310, the target voltage of the direct-current power supply mechanism 120 and the terminal voltage of the direct-current power storage mechanism 140 are matched within the predetermined adaptive voltage range ΔV.
(6) The power mixing apparatus further includes supply voltage measurement means 410 that measures a voltage of the direct-current output terminal 160 and interruption means 420 that interrupts the connection between the input/output terminal of the direct-current power storage mechanism 140 and the direct-current output terminal 160. When a voltage value of the direct-current output terminal 160 measured by the supply voltage measurement means 410 exceeds a predetermined charge end voltage, the interrupt means 420 interrupts the connection between the input/output terminal of the direct-current power storage mechanism 140 and the direct-current output terminal 160.
(7) in the power mixing apparatus, when the voltage value of the direct-current output terminal 160 measured by the supply voltage measurement means 410 falls below a predetermined charge restore voltage, the interruption means 420 restores the connection between the input/output terminal of the direct-current power storage mechanism 140 and the direct-current output terminal 160.
(8) In the power mixing apparatus, when the voltage value of the direct-current output terminal 160 measured by the supply voltage measurement means 410 falls below a predetermined discharge end voltage, the interruption means 420 interrupts the connection between the input/output terminal of the direct-current power storage mechanism 140 and the direct-current output terminal 160.
(9) In the power mixing apparatus, when the voltage value of the direct-current output terminal 160 measured by the supply voltage measurement means 410 exceeds a predetermined discharge restore voltage, the interruption means 420 restores the connection between the input/output terminal of the direct-current power storage mechanism 140 and the direct-current output terminal 160.
(10) The power mixing apparatus further includes signal generation means 510 that when the voltage value of the direct-current output terminal 160 measured by the supply voltage measurement means 410 exceeds the predetermined charge end voltage, outputs a surplus power generation signal.
(11) The power mixing apparatus further includes a direct current-alternating current converter 1010 that includes a direct-current input terminal and an alternating-current output terminal 1020. The direct-current input terminal of the direct current-alternating current converter 1010 is connected to the direct-current output terminal 160. The alternating-current output terminal 1020 of the direct current-alternating current converter 1010 supplies alternating-current power to an alternating-current load.

### REFERENCE SIGNS LIST

100 . . . power supply system, 120 . . . direct-current power supply mechanism, 122 . . . direct-current generator, 124 . . . alternating current-direct current converter, 126 . . . alternating-current power, 140 . . . direct-current power storage mechanism, 142 . . . accumulator, 144 . . . vehicle storage battery, 160 . . . direct-current output terminal, 200 . . . power supply system, 210 . . . current backflow prevention mechanism, 300 . . . power supply system, 310 . . . variable voltage source, 400 . . . power supply system, 410 . . . supply voltage measurement means, 420 . . . interruption means, 422 . . . backflow prevention diode, 424 . . . switch, 426 . . . diode, 428 . . . switch, 500 . . . power supply system, 510 . . . signal generation means 510, 600 . . . power supply system, 610 . . . less-important load, 620 . . . important load, 630 . . . load controller, 700 . . . power supply system, 800 . . . power supply system, 810 . . . power measurement means, 820 . . . signal generation means, 900 . . . power supply system, 910 . . . less-important load, 920 . . . important load, 930 . . . load controller, 1000 . . . power supply system, 1010 . . . direct current-alternating current converter, 1020 . . . alternating-current output terminal.

1. A power supply system comprising:
a direct-current power supply mechanism that supplies direct-current power;
a direct-current power storage mechanism that stores direct-current power; and
a direct-current output terminal that outputs direct-current power supplied from the direct-current power supply mechanism, the direct-current power storage mechanism, or both to a direct-current load, wherein
an output of the direct-current power supply mechanism and the direct-current output terminal are connected directly or through a current backflow prevention mechanism,
an input/output terminal of the direct-current power storage mechanism and the direct-current output terminal are connected directly or through a power backflow prevention mechanism, and
a target voltage of the direct-current power supply mechanism and a terminal voltage of the direct-current power storage mechanism are matched within a predetermined adaptive voltage range.

2. The power supply system of claim 1, wherein
the direct-current power supply mechanism comprises one or more direct-current generators, and
by controlling a connection state of the direct-current generators and thus controlling the target voltage of the direct-current power supply mechanism, the target voltage of the direct-current power supply mechanism and the terminal voltage of the direct-current power storage mechanism are matched within the predetermined adaptive voltage range.

3. The power supply system of claim 2, wherein
the direct-current power supply mechanism further comprises an alternating current-direct current converter that converts received alternating-current power into direct-current power, and
by controlling a connection state of the direct-current generators and the alternating current-direct current converter and thus controlling the target voltage of the direct-current power supply mechanism, the target voltage of the direct-current power supply mechanism and the terminal voltage of the direct-current power storage mechanism are matched within the predetermined adaptive voltage range.

4. The power supply system of claim 2, further comprising a state switch mechanism that switches between connection states of the direct-current generators, wherein
by dynamically changing the number of series connections of the direct-current generators using the state switch mechanism, the target voltage of the direct-current power supply mechanism and the terminal voltage of the direct-current power storage mechanism are matched within the predetermined adaptive voltage range.

5. The power supply system of claim 1, wherein
the direct-current power storage mechanism comprises one or more accumulators, and
by controlling a connection state of the accumulators and thus controlling the terminal voltage of the direct-current power storage mechanism, the target voltage of the direct-current power supply mechanism and the terminal voltage of the direct-current power storage mechanism are matched within the predetermined adaptive voltage range.

6. The power supply system of claim 5, wherein
the direct-current power storage mechanism comprises a vehicle storage battery mounted on an electric vehicle, and
by controlling a connection state of the accumulators and the vehicle storage battery and thus controlling the terminal voltage of the direct-current power storage mechanism, the target voltage of the direct-current power supply mechanism and the terminal voltage of the direct-current power storage mechanism are matched within the predetermined adaptive voltage range.

7. The power supply system of claim 5, further comprising a state switch mechanism that switches between connection states of the accumulators, wherein
by dynamically changing the number of series connections of the accumulators using the state switch mechanism, the target voltage of the direct-current power supply mechanism and the terminal voltage of the direct-current power storage mechanism are matched within the predetermined adaptive voltage range.

8. The power supply system of claim 1, wherein the direct-current power storage mechanism is a vehicle storage battery mounted on an electric vehicle.

9. The power supply system of claim 1, further comprising a variable voltage source connected to the direct-current power storage mechanism in series, wherein
by controlling a voltage of the variable voltage source, the target voltage of the direct-current power supply mechanism and the terminal voltage of the direct-current power storage mechanism are matched within the predetermined adaptive voltage range.

10. The power supply system of claim 1, further comprising:
supply voltage measurement means that measures a voltage of the direct-current output terminal; and
interruption means that interrupts the connection between the input/output terminal of the direct-current power storage mechanism and the direct-current output terminal, wherein
when a voltage value of the direct-current output terminal measured by the supply voltage measurement means exceeds a predetermined charge end voltage, the interrupt means interrupts the connection between the input/output terminal of the direct-current power storage mechanism and the direct-current output terminal.

11. The power supply system of claim 10, wherein when the voltage value of the direct-current output terminal measured by the supply voltage measurement means falls below a predetermined charge restore voltage, the interrupt means restores the connection between the input/output terminal of the direct-current power storage mechanism and the direct-current output terminal.

12. The power supply system of claim 10, wherein when the voltage value of the direct-current output terminal measured by the supply voltage measurement means falls below a discharge end voltage, the interrupt means interrupts the connection between the input/output terminal of the direct-current power storage mechanism and the direct-current output terminal.

13. The power supply system of claim 12, wherein when the voltage value of the direct-current output terminal measured by the supply voltage measurement means exceeds a predetermined discharge restore voltage, the interrupt means restores the connection between the input/output terminal of the direct-current power storage mechanism and the direct-current output terminal.

14. The power supply system of claim 10, further comprising signal generation means that when the voltage value of the direct-current output terminal measured by the supply voltage measurement means exceeds the predetermined charge end voltage, outputs a surplus power generation signal.

15. The power supply system of claim 14, further comprising one or more loads that receive power supply from the direct-current power supply mechanism, the direct-current power storage mechanism, or both, wherein
when the surplus power generation signal is received, activation of a predetermined, less-important load of the loads is permitted.

16-22. (canceled)

23. A power mixing apparatus comprising:
a direct-current power receiving terminal that receives direct-current power from a direct-current power supply mechanism;
a direct-current power storage mechanism that stores direct-current power; and
a direct-current output terminal that outputs direct-current power supplied from the direct-current power supply mechanism, the direct-current power storage mechanism, or both to a direct-current load, wherein
the direct-current power receiving terminal and the direct-current output terminal are connected directly or through a current backflow prevention mechanism,
an input/output terminal of the direct-current power storage mechanism and the direct-current output terminal are connected directly or through a power backflow prevention mechanism, and
a target voltage of the direct-current power supply mechanism connected to the direct-current power receiving terminal and a terminal voltage of the direct-current power storage mechanism are matched within a predetermined adaptive voltage range.

24. The power mixing apparatus of claim 23, wherein
the direct-current power storage mechanism comprises one or more accumulators, and
by controlling a connection state of the accumulators and thus controlling the terminal voltage of the direct-current power storage mechanism, the target voltage of the direct-current power supply mechanism and the terminal voltage of the direct-current power storage mechanism are matched within the predetermined adaptive voltage range.

25. The power mixing apparatus of claim 24, wherein
the direct-current power storage mechanism comprises a vehicle storage battery mounted on an electric vehicle, and
by controlling a connection state of the accumulators and the vehicle storage battery and thus controlling the terminal voltage of the direct-current power storage mechanism, the target voltage of the direct-current power supply mechanism and the terminal voltage of the direct-current power storage mechanism are matched within the predetermined adaptive voltage range.

26. The power mixing apparatus of claim 24, further comprising a state switch mechanism that switches between connection states of the accumulators, wherein
by dynamically changing the number of series connections of the accumulators using the state switch mechanism, the target voltage of the direct-current power supply mechanism and the terminal voltage of the direct-current power storage mechanism are matched within the predetermined adaptive voltage range.

27. The power mixing apparatus of claim 23, further comprising a variable voltage source connected to the direct-current power storage mechanism in series, wherein
by controlling a voltage of the variable voltage source, the target voltage of the direct-current power supply mechanism and the terminal voltage of the direct-current power storage mechanism are matched within the predetermined adaptive voltage range.

28-33. (canceled)
